(19) United States
(12) Patent Application Publication
(10) Pub. No.: US 2008/0308746 A1
(43) Pub. Date: Dec. 18, 2008

(54) Optical Fluorescence Tomography

(75) Inventor: Bernhard Gleich, Hamburg (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/094,868

(22) PCT Filed: Nov. 17, 2006
(86) PCT No.: PCT/IB2006/054316

§ 371 Date: May 23, 2008

(30) Foreign Application Priority Data
Nov. 25, 2005 (EP) 05111279.5

(51) Int. Cl. G01N 21/64

(52) U.S. Cl. 250/459.1

(57) ABSTRACT

The invention relates to an optical fluorescence tomography system of biological targets. For increasing the resolution an the penetration depth of the impact radiation, in order to result a better depth signal, the biological target is supplied with a fluorescence dye (Material), bleachable by impact radiation, wherein a controllable dynamic tissue-wise bleaching-effect of the fluorescence dye is generated, so that by time dependant measuring of the maximum fluorescence response signal can be correlated to the actual selective bleaching front in depth.

The invention relates to an optical fluorescence tomography and to an optical fluorescence tomography system of biological targets, wherein the target is supplied with a fluorescent agent.

Optical fluorescence tomography is a good modality for tissue specific imaging, so called molecular imaging. A lot of molecular imaging contrast agent research is aimed to fluorescent dyes. The main disadvantage of optical tomography is limited penetration depth and low resolution. This currently limits the use of optical fluorescence tomography to animal research and human tissue with a good accessibility, like in breast and joints diagnostics.

U.S. Pat. No. 5,949,077 discloses a method, whereby the object or the biological target is supplied with a luminescent dye, the excitation light is filtered out and the turbid medium is supplied with an absorbing dye for luminescent light.

A problem is, that biological material induce scattering of the luminescent light. This fact sets limitation to depth resolution.

For example the human body has a high transparency for infrared light. A disadvantage of such a target is, that the human body as a target causes very strong scattering of the emitted response signal as well as the light impact. Tomography systems in the state of the art therefore solve this problem by mathematical modeling of the response signal field. The resulted display is therefore a virtual picture of the target, and because of the scattering effect a reconstructed picture only with low resolution.

Nevertheless, the fluorescence tomography uses only harmless radiation to the human body, which is an important aspect.

Against this background, the invention is based on the object of improving a method of optical fluorescence tomography and improving an optical fluorescence tomography system by which a better resolution, especially a better depth resolution is resulted.

The stated object is achieved for a method of this generic type by characterizing features of patent claim 1.

Further embodiments of this method are characterized in the dependant claims 2-7

The stated object is also achieved for a tomography system itself, by characterizing features of patent claim 8.

Further embodiments of this tomography system are characterized in dependent claims 9-12.

The stated object of the invention is achieved for a method, by the features that the target is supplied with a fluorescent agent, which is photo-bleachable by impact radiation in a definite way, so that a controllable dynamic tissue-wise bleaching-effect of the fluorescence dye is generated in the target, and by time dependant measuring of the maximum fluorescence response signal, this can be correlated to the actual selective bleaching front in depth.

This means, that the low photo-stable fluorescent agent is photo-bleached thus enhancing the signal to noise ratio of the fluorescence light from deeper areas of the target. The photo-luminescent agent will be photo-bleached in depth as a function of time. In this way, the front of signal intensity moves into depth, so that it is possible to come stepwise or continuously to a dynamic imaging with increasing depth.

Any fluorescent dye will be destroyed after prolonged irradiation with light. The average number of photons a dye emits before being finally bleached, is between 10⁶ and 1, depending on the chemical composition. Traditionally, only the stable dyes were regarded as valuable tracers in the state of the art, because they can produce more signal intensity integrated over time. But taking the approximate 10 dB/cm light absorption in human tissue into account, it can be computed that in tissues lying deeper, each dye molecule will only emit a few photons. Consequently, a low photo-stability of the dye is no disadvantage in medical imaging.

The low photo-stability of the dye in the invention is turned into an advantage by selective bleaching of tissues. This is the deep physical sense of the invention.

Assume two layers of fluorescent dye accumulating tissue. One is near the surface and the other is 4 cm deep under the surface of the tissue. Now the signal intensity from the 4 cm deep layer will be only 10⁻⁸ of the signal intensity of the surface layer. Therefore, it is almost impossible to see the accumulation lying deep under the surface of the tissue. When applying intense light, the upper layer is bleached while the lower layer is virtually unaltered. To make it quantitative, assume the light integrated intensity is such that the signal intensity at the lower layer is reduced to

e^{-0.01}=99%

Then, the upper layer is depleted to a signal intensity of

e^{-0.01*10000}=e⁻¹⁰⁰=3*10⁻⁴⁴

This means that the fluorescence light of the deeper tissue can be identified easily.

This fact is further illustrated later on. The bleached molecules form a quite sharp front, so that a information from depth having a better contrast is generated directly from response signal.

A first embodiment of the invention is given by a logical and/or chronological range of method or process features or steps.

By this the final image reconstruction is realized by

a) perform conventional diffuse optical tomography (DOT) and conventional optical fluorescence tomography and calculate absorption, fluorescence and scattering coefficients,
b) calculate the expected light level in the object for the aforesaid bleaching,
c) cause definite bleaching by light impact from the additional light source and calculate the expected bleaching from the light,
d) perform conventional DOT and fluorescence tomography to these data,
e) reconstruct absorption, fluorescence and scattering coefficients using the pre-knowledge of the reduced fluorescence in some areas,
f) repeat step b) until measurements are performed or data is processed.

In steps a) and b) it is also possible to make some testing steps before, and the real-time measurement afterwards. So the method is not exclusively fixed to the aforesaid chronology but sometimes some of the steps can be permuted. The logical combination of the aforesaid features is of importance.

It must also be said, that in some steps conventional fluorescence tomography DOT is used, but it is combined with aforesaid steps and new features in an inventive way. Conventional DOT is combined with the invention. Conventional features are runtime analysis of high frequency light for example. The exploitation of the heart beat of the patient for example can be used for modulation of the optical contrast.

Conventional DOT is described in A. H. Hielscher et al, “Near infrared diffuse optical tomography” Disease Markers 18 (2002) 313-337; and in A. B. Milstein et al “Fluorescence Optical Diffuse Tomography” Applied Optics Vol. 42, Nr 16 (1. Jun. 2003) 3081-3094.

A further embodiment of the invention is that the dynamic bleaching-effect is controlled by variation of the deposited impact radiation energy. The energy impact of the additional light source is an integral time-related energy; it is not the photon energy. By variation of the impact energy, the complex system of bleaching-effect parameters of the system, and of the target, and of the fluorescent agent can be considered in common.

A further embodiment discloses, that the maximum response signal is detected stepwise in intervals, wherein the time intervals are changeable. By this, a stepwise display of the depth information can be resulted.

An alternative embodiment is, that the maximum response signal is detected continuously. By continuous detection, the depth information can be resulted in a sharp image with high contrast.

A further embodiment of the invention is, that a fluorescent dye or agent with a low photo-stability in at least the light energy range of the impact radiation is used. The bleaching effect is used for detection of propagating depth information during operation.

An advantageous embodiment is, to operate the data storage means adaptively. By this, parameter evaluation and optimization will become automatically self-learning and/or self optimizing during operation of the tomography system.

The stated object of the invention is achieved for a tomography system, by the features, that for living biological targets which are provided with a fluorescent agent before measuring treatment, wherein the target is impacted by a radiation source and an additional high intensity monochromatic light source, and the active response signal from the target is detected by an optical detector, and the response signal is detected and stored electronically as a function of time data in an adaptive, data storage means.

The light is used for imaging as well as for controlled bleaching at the same time, during the same process. This is one of the benefits of the invention.

High intensity monochromatic light source means in detail, that the absolute minimum for light power used is five watt. A very effective imaging will be caused above 15 watt. Consequently, preferably the used power for this light source should be at least 15 watt up to a power which can be exposed individually to the patient, recognizing his individual tolerance. The wavelength should be in a monochromatic accuracy of a band of ≦30 nanometers.

A first embodiment of the invention describes, that the system contains an additional light source, which is at least adjustable in frequency and/or power. By this the controlled depth-propagating bleaching procedure can be caused by the additional light source. Therefore, the additional light source can be adjusted at least automatically by response-signal optimization in frequency and/or power.

A further embodiment of the inventive system is, that inside the system a correlation means, the time dependant response signal data is correlated by a tissue-wise time-dependant bleaching effect, in order to reconstruct or generate in situ a dynamic 3-dimensional picture of the target in the depth.

A further embodiment is, that the 3-dimensional picture data are displayed on a screen. Imaging with depth information can make objects visible in the depth of the target, which is usually tissue.

A further embodiment is, that the fluorescence tomography system is supplied with an electronic data interface, in order to generate a picture or picture sequence in situ, via a data network to a further expert, which can be situated distant. This facilitates sending the diagnostic data directly to another expert, to discuss with him the result.

An embodiment of the invention is shown in the drawings.

### DRAWINGS

FIG. 1 usage of depth propagating bleaching effect

FIG. 2 tomography system

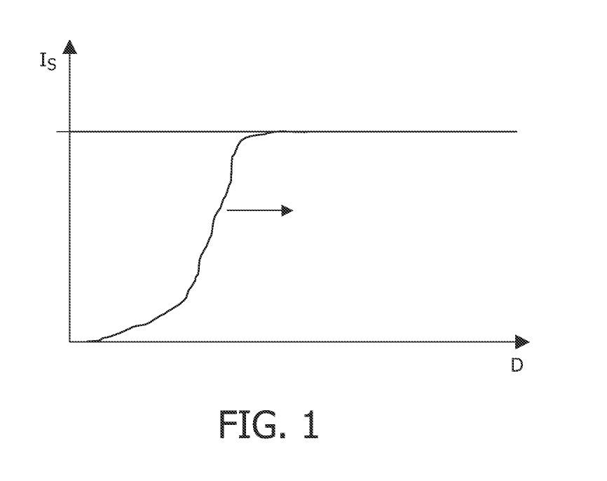

In FIG. 1 the method is displayed as Signal intensity Iₛ(D) as a function of the depth D of the target. The molecules of the fluorescent agent supplied to the biological target, for example a human, form a quite sharp front in response signal intensity Iₛ(D) under irradiation impact.

A constant light intensity of the impact irradiation, the front of bleached molecules advances slower and slower. So the light intensity has to be increased. The limit of the ultimate reachable depth is the tolerable light power in the patient. This can be felt as a heating exposure. But this is no severe limitation, as at this depth, the signal intensity of the fluorescent photons vanishes too, and the ultimate penetration depth of optical methods is reached. (About 10 cm in reflection mode)

With other words, like already mentioned above, the bleaching effect is advancing by time into the depth. So the surface-near upper tissues which are bleached first, will not have any longer significant contribution to the response signal. In result, it can be said, that the forgoing bleaching by radiation exposure will penetrate deeper and deeper, so that only the actual response signal is a signal definitively coming out of the actual defined bleaching depth, declared as bleaching front.

The main difference of such a system to a traditional optical tomography system is the reconstruction algorithm, and an additional high intensity monochromatic light source.

Ideally, the additional light source can change frequency. So, in the beginning, the light source is not tuned to the frequency, where the light penetrates best into the tissue. This uses initially higher power for bleaching but produces a sharper bleaching profile.

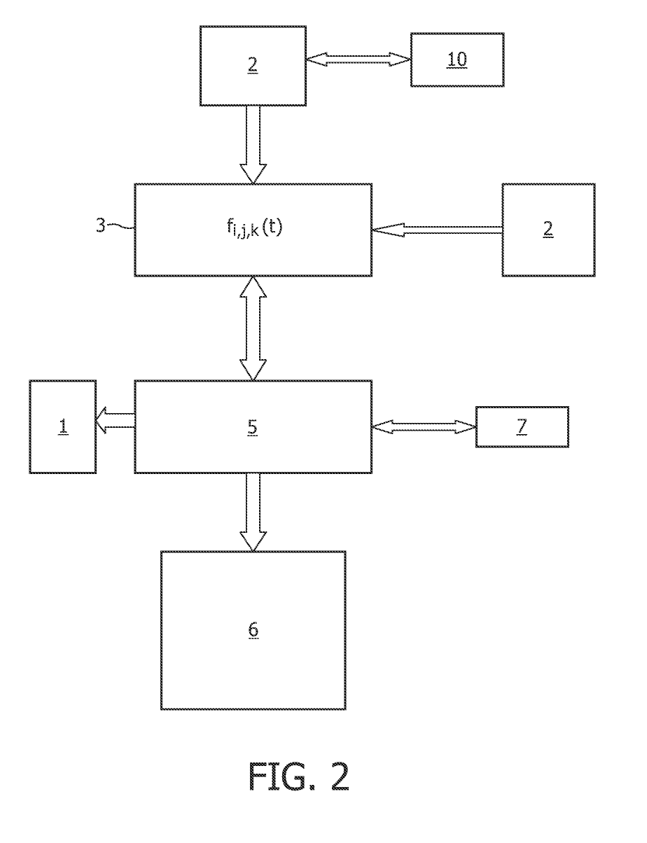

FIG. 2 displays a simplified version of the inventive fluorescent tomography system, where only the important parts are displayed.

Response signals from the target will be received by the optical detector 2. These signals are forwarded to an electronic data storage 3 which is organized as a multi-dimensional data storage field. The incoming signals must be stored with a correlated time dependency, because the bleaching effect and therefore resulted depth information have to be correlated in situ.

The optical detector 2 can be connected logically to the stearing of the additional monochromatic light source 10, in order to optimize the bleaching process. Therefore, the additional light source 10 can be steared in power and/or in frequency optimization.

Also the normal light source for generating response signal from the distributed fluorescence agent in the target can be steared by detector-signal optimization.

So the signals stored in the data field 3 are stored with their time dependency, so that a picture of the object can be imagined as a real display of the 3 dimensional depth information.

In order to generate a fixed time dependency, the system is supplied by an adjustable clock 4, so that optimized time intervals can be adjusted to the actual bleaching parameters of the fluorescent agent.

The pre-stored data of the data storage 3 are interchanged with data correlation means 5, in order to correlate the sensor signals, which are pre-stored as a function of for example Cartesian coordinates in dependency of time f_{i,j,k}(t), so that the data can be transformed into an image with depth information of the target.

To the end of optimizing the generation of an image, the radiation source can be influenced at least additionally by the reconstruction means 5. So if the contrast is to be optimized, for example the primary radiation source 1 for signal generation can be supplied by higher energy input.

The data connection between data storage 3 and data correlation 5 is bidirectional, in order to organize and to operate as an adaptive data storage, learning and optimizing in situ during operation.

Finally, the correlated and optimized data can be transformed into a real image of the depth of the target, displayed on a display or screen 6, which could be a part of the system, or which can be located at another place.

To transmit image data, the reconstruction means 5 is connected via a network interface 7. Image data can be transmitted to an expert located at another place. This facilitates realization of diagnostic procedures in situ by data- and/or telephone-conference around the world.

The invention results in some important advantages.

The invention greatly enhances the detection limit of fluorescent markers in deep lying tissues.

It improves the resolution in all depth, according to the object of the invention.

A further advantage is, that the method adds only little complexity to the hardware, that means to the needed electronic components for realizing the invention.

1. Method for optical fluorescence tomography of biological targets, wherein the target is supplied with a fluorescent agent, which is photo-bleachable by impact radiation in a definite way, so that a controllable dynamic tissue-wise bleaching-effect of the fluorescence dye is generated, and by time dependent measuring of the maximum fluorescence response signal correlated to the actual selective bleaching front in depth.

2. Method according to claim 1, characterized in that the image reconstruction is performed in the following way,
a) perform conventional diffuse optical tomography (DOT) and conventional optical fluorescence tomography and calculate absorption, fluorescence and scattering coefficients,
b) calculate the expected light level in the object for the aforesaid bleaching,
c) cause definite bleaching by light impact from the additional light source and calculate the expected bleaching from the light,
d) perform conventional DOT and fluorescence tomography to these data,
e) reconstruct absorption, fluorescence and scattering coefficients using the pre-knowledge of the reduced fluorescence in some areas,
f) repeat at step b until measurements are performed or data are processed.

3. Method according to claim 1, characterized in that the dynamic bleaching-effect is controlled by variation of the deposited impact radiation energy.

4. Method according to claim 1, characterized in that the response signal is detected stepwise in intervals, wherein the time intervals are changeable.

5. Method according to claim 1, characterized in that the response signal is detected continuously.

6. Method according to claim 1, characterized in that a fluorescent dye or agent with a low photo-stability in at least the light energy range of the deposited impact radiation is used.

7. Method according to claim 1, characterized in that the data storage means will be operated adaptively.

8. Optical fluorescence tomography system particularly for living biological targets which are provided with a fluorescent agent before measuring treatment, wherein the target is impacted by a radiation source and an additional high intensity monochromatic light source, and the active response signal from the target is detected by an optical detector, and the response signal is detected and stored electronically as a function of time data in adaptive data storage means.

9. Optical fluorescence tomography system according to claim 8, characterized in that the system contains an additional light source (10), which is at least adjustable in frequency and/or power.

10. Optical fluorescence tomography system according to claim 8, characterized in that inside a reconstruction means, the time dependant response signal data is correlated by a tissue-wise time-dependant bleaching effect, in order to reconstruct or generate in situ a dynamic 3-dimensional picture of the target in the depth.

11. Optical fluorescence tomography system, according to claim 10, characterized in that the 3-dimensional picture data are displayed on a screen.

12. Optical fluorescence tomography system, according to claim 8, characterized in that the tomography system is supplied with an electronic data interface, in order to generate a picture or picture sequence in situ, via data network to another or further expert.
